(19) United States
(12) Patent Application Publication
(10) Pub. No.: US 2025/0335232 A1
(43) Pub. Date: Oct. 30, 2025

(54) VIRTUAL MACHINE DEPLOYMENT AUTOMATION

(71) Applicant: Insight Direct USA, Inc., Chandler, AZ (US)

(72) Inventor: Michael General, Hudson, FL (US)

(21) Appl. No.: 19/189,675

(22) Filed: Apr. 25, 2025

Related U.S. Application Data
(60) Provisional application No. 63/639,207, filed on Apr. 26, 2024.

(51) Int. Cl. G06F 9/455; G06F 9/445

(52) U.S. Cl. CPC G06F 9/45558; G06F 9/44505; G06F 2009/45562; G06F 2009/45591

(57) ABSTRACT

A system for generating a virtual machine on a host computer includes a processor, and input/output device operably connected to the processor, and computer-readable memory operably connected to the processor. The input/output device is configured to display a user interface. The computer-readable memory is encoded with instructions that, when executed by the processor, cause the system to perform the following steps. The system provides a virtual machine attribute input display to a user via the user interface. The system receives virtual machine attributes via the user interface. The system deploys a virtual machine via a hypervisor based upon the virtual machine attributes. The system configures an operating system within the virtual machine. The system configures one or more applications within the virtual machine. The system verifies an installation status and a registration status of the one or more applications.

### CROSS-REFERENCE TO RELATED APPLICATION

This application is a nonprovisional application claiming the benefit of U.S. provisional Ser. No. 63/639,207, filed on Apr. 26, 2024, and entitled “VIRTUAL MACHINE DEPLOYMENT AUTOMATION” by Michael General.

### BACKGROUND

A virtual machine can be a software-based simulation of a physical computer system. A virtual machine can, for example, run various operating systems and applications. Dedicated amounts of processing power and memory can be partitioned to the virtual machine from a computer, or from a host computer via a remote server in a data center. Setting up a virtual machine can be complex and time consuming as different hardware and software specifications affecting performance and compatibility need to be considered. Thus, a system for efficiently generating a virtual machine is desirable.

### SUMMARY

A system for generating a virtual machine on a host computer includes a processor, and input/output device operably connected to the processor, and computer-readable memory operably connected to the processor. The input/output device is configured to display a user interface. The computer-readable memory is encoded with instructions that, when executed by the processor, cause the system to perform the following steps. The system provides a virtual machine attribute input display to a user via the user interface. The system receives virtual machine attributes via the user interface. The system deploys a virtual machine via a hypervisor based upon the virtual machine attributes. The system configures an operating system within the virtual machine. The system configures one or more applications within the virtual machine. The system verifies an installation status and a registration status of the one or more applications.

### BRIEF DESCRIPTION OF THE DRAWINGS

FIG. 1 is a schematic view of an example system for generating a virtual machine on a host computer.

FIG. 2 is a flowchart describing a method for generating a virtual machine on a host computer.

### DETAILED DESCRIPTION

The techniques of this disclosure relate to a system for automatically generating a virtual machine on a host computer. The virtual machine is configured to run a particular operating system and application software. The process for setting up the virtual machine includes creating a virtual machine that includes the operating system, configuring the operating, installing applications, and verifying the installation status of the operating system and the applications. This process allows for automatic and time-efficient creation and deployment of virtual machines that are customized per defined attributes. Further, the process ensures that the created virtual machines will be compatible with the host computer.

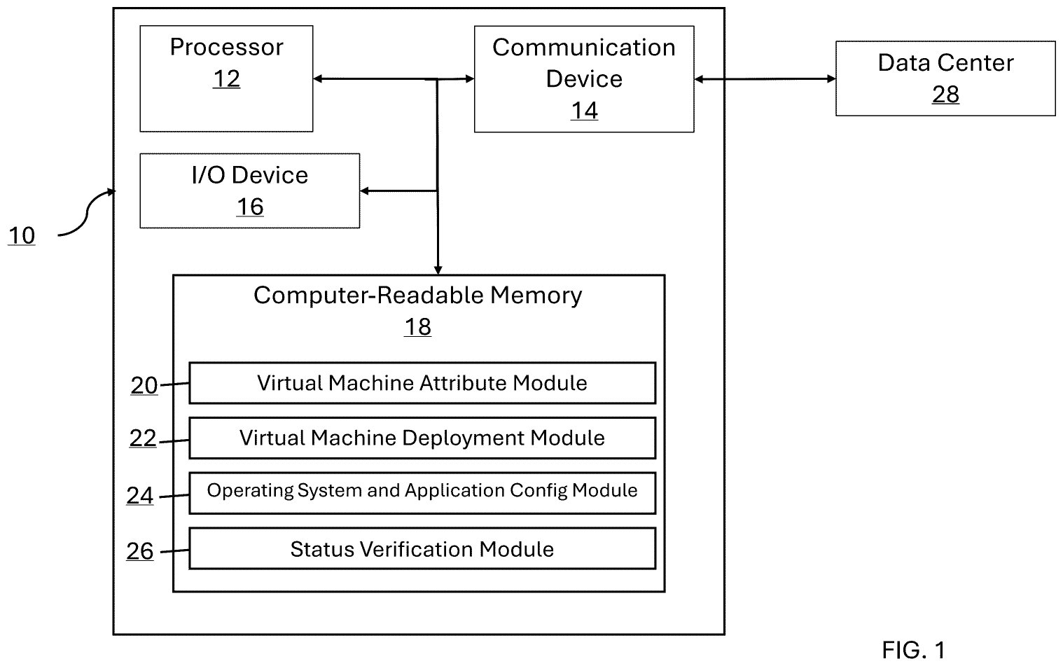

FIG. 1 is a schematic view of system 10 for generating a virtual machine on a host computer. As depicted in FIG. 1, system 10 includes processor 12, communication device 14, input/output device 16, and computer-readable memory 18. Computer-readable memory 18 includes virtual machine attribute module 20, virtual machine deployment module 22, operating system and application configuration module 24, and status verification module 26. System 10 is operably connected to data center 28, wherein data center 28 is an external data center which houses the host computer. The host computer provides the computing resources and storage systems of the virtual machine. It is understood that in some embodiments, computing resources and storage systems of system 10 are instead used to support the needs of the virtual machine via a partition (i.e., instead of external resources of data center 28).

Processor 12, communication device 14, input/output device 16, and computer-readable memory 18 are interconnected within system 10. Processor 12 can execute software, applications, and/or programs stored on memory 18. Examples of processor 12 can include one or more of a processor, a microprocessor, a controller, a digital signal processor (DSP), an application specific integrated circuit (ASIC), a field-programmable gate array (FPGA), or other equivalent discrete or integrated logic circuitry. Processor 12 can be entirely or partially mounted on one or more circuit boards.

Computer-readable memory 18 is configured to store information and, in some examples, can be described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, computer-readable memory 18 is a temporary memory. As used herein, a temporary memory refers to a memory having a primary purpose that is not long-term storage. Computer-readable memory 18, in some examples, is described as volatile memory. As used herein, a volatile memory refers to a memory that does not maintain stored contents when power to the memory is turned off. Examples of volatile memories can include random access memories (RAM), dynamic random access memories (DRAM), static random access memories (SRAM), and other forms of volatile memories. In some examples, computer-readable memory 18 is used to store program instructions for execution by processor 12. Computer-readable memory 18, in one example, is used by software, applications, and/or programs running on system 10 to temporarily store information during program execution.

Computer-readable memory 18, in some examples, also includes one or more computer-readable storage media. Computer-readable memory 18 can be configured to store larger amounts of information than volatile memory. Computer-readable memory 18 can further be configured for long-term storage of information. In some examples, computer-readable memory 18 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

Input/output device 16 is an input and/or output device that enables a user to control the operation of system 10. Input/output device 16 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users, machines, or other computing devices.

Communication device 14 is an input and/or output device that enables system 10 to electrically communicate with data center 28. Communication device 14 can include a network interface card (NIC), a modem, a bridge, a hub, and/or a router, which may communicate with other network-attached components via wired and/or wireless connections.

Computer-readable memory 18 can store instructions that, when executed by processor 12, cause system 10 to perform one or more methods and/or other functions described herein. Instructions can include software, applications, routines, algorithms, and/or other code stored on computer-readable memory 18, which can be described in terms of one or more logical and/or functional groups, referred to as modules. For example, computer-readable memory 18 can include virtual machine attribute module 20, virtual machine deployment module 22, operating system and application configuration module 24, and status verification module 26, each of which perform certain functionally-related and/or logically-related tasks to accomplish the methods described herein. While the example of FIG. 1 is illustrated and described with respect to the depicted modules, it should be understood that in other examples of system 10, computer-readable memory 18 can include any number of modules.

Virtual machine attribute module 20 contains instructions to generate a user interface display for receiving attributes of the desired virtual machine. Execution of virtual machine attribute module 20 via processor 12 causes input/output device 20 to display one or more fields and/or other information to the user via the user interface. Within the user interface, the user is prompted to provide various attributes of the virtual machine. The following fields of the user interface are examples of attributes that can be received from the user and are merely intended as examples. It is understood that additional or alternative attributes of the virtual machine can be received via the user interface.

The user interface of input/output device 16 can display a field for a server hostname. Upon receiving the server hostname from the user, system 10 can automatically check to ensure that the hostname is not active on a network of connected computing devices. System 10 can further automatically check if any Domain Name System (DNS) records exist for the hostname. Upon performing such checks, system 10 can then determine whether the hostname is available for use. In some examples, where a conflict with the hostname is found within the network or within the DNS records, the user is prompted via the user interface to enter a new hostname.

The user interface of input/output device 16 can display a field for selection of an operating system. The user interface can display a selection of operating system having templates available to use within the network. The operating systems can be selected from a predefined list of operating systems based upon the availability of such operating systems within the network.

The user interface of input/output device 16 can display a field for selection of a data center location. The data center location corresponds to a location in which the virtual machine is hosted. In some examples, the data center is an external computer, not housed within system 10, upon which the virtual machine is hosted. The field for selection of the data center location can present a predefined list of one or more data centers for the user to select from.

The user interface of input/output device 16 can display a field for selection of a memory quantity value (e.g., via a numerical input field). The memory quantity value can be a value indicative of the amount of memory requested by the user for the virtual machine. In some embodiments, the memory quantity value can be indicative of random access memory, long-term storage memory, or any combination thereof. In some embodiments, upon receiving the memory quantity value, system 10 can perform a validation check on memory availability. System 10 can, for example, receive, via communication device 14, an indication of available memory within the computing device of data center 28. System 10 can thus evaluate whether sufficient memory exists to provide the user with the requested amount of memory. Additionally or alternatively, system 10 can include a predetermined memory threshold value, such that the user requested amount of memory is invalid unless it is below the predetermined memory threshold value. In some embodiments, where the memory quantity value input by the user exceeds the available memory, the user is prompted via the user interface to enter a lower memory quantity value.

The user interface of input/output device 16 can display a field for selection of a computer processing unit (CPU) value (e.g., via a numerical input field). The CPU value can be indicative of the processor utilization across the CPU cores of the host computer within data center 28. In some embodiments, upon receiving the CPU value, system 10 can perform a validation check on CPU availability. System 10 can, for example, receive, via communication device 14, an indication of available CPU resources within the computing device of data center 28. System 10 can thus evaluate whether sufficient CPU resources exist to provide the user with the requested amount of CPU processing power. In some embodiments, where the CPU value input by the user exceeds the available CPU resources, the user is prompted via the user interface to enter a lower CPU value.

The user interface of input/output device 16 can display a field for indication as to whether a data disk is required. In some embodiments, such a field is a Boolean option. Upon a user indicating that a data disk is required, the user is further prompted to indicate the size of the data disk via, for example, a numerical input field. System 10 can further be configured to scan the data disk to determine whether the data disk has been formatted. In response to a data disk being requested and the requested data disk being a non-formatted disk, system 10 can transmit instructions to the host computer to format the data disk.

The aforementioned features of the user interface are used to receive various attributes of the virtual machine as input by the user. It is understood that the aforementioned features are examples and that additional or alternative fields can be displayed via the user interface to collect additional or alternative attributes of the virtual machine which can thus result in additional or alternative customization of the virtual machine.

Virtual machine deployment module 22 contains instructions to deploy the virtual machine via a hypervisor. Execution of virtual machine deployment module 22 via processor 12 causes the virtual machine to be deployed based upon the attributes received from the user interface. In one example, prior to deployment, a user interface element is displayed, asking the user to confirm the deployment of the virtual machine with the selected attributes. Additionally, upon execution of virtual machine deployment module 22, an internet protocol (IP) address is obtained for the virtual machine. In one example, the IP address is obtained from an external IP address management system. Upon receiving the IP address, system 10 verifies the IP address to ensure that the IP address for the virtual machine is not already in use.

Upon confirming the IP address, system 10 deploys the virtual machine via a hypervisor. The hypervisor can be any computer software or hardware enabling a user to host one or more virtual machines. The hypervisor can, for example, enable the user to access the one or more virtual machines and allocate processing power, memory, and other resources of the host computer to the virtual machine.

In some embodiments, upon deployment of the virtual machine, a data disk is created and attached to the virtual machine. Such an embodiment can occur if the user indicates that a data disk is required via the user interface (i.e., as described with respect to virtual machine attribute module 20).

In some embodiments, upon deployment of the virtual machine, the hypervisor is set to automatically update. Further, upon deployment of the virtual machine, the virtual machine is powered on, and system 10 verifies that the hypervisor is running and updated.

Operating system and application configuration module 24 contains instructions to configure the operating system and to configure the applications to be installed within the virtual machine. Execution of operating system and application configuration module 24 via processor 12 causes the operating system to be configured based upon user input.

Upon execution of operating system and application configuration module 24, an operating system configuration user interface is displayed via input/output device 16. The following description of the elements and information received from the operating system configuration user interface is merely intended to be an example and it is recognized that additional or alternative examples of operating system configurations can be used.

The user interface can request a user electronic communication means. The electronic communication means (e.g., email, or other communication means) can be used to send reports and logs of server builds. The user interface can request an alternative name of the server (e.g., in a case where such a name is required for the virtual machine). The user interface can provide an input field for a patch schedule, wherein the patch schedule indicates when patches should be applied to the virtual machine.

The user interface can request an input for creating users and groups. In such an example, the user interface provides a Boolean input field configured to receive user input as to whether a standard users and groups should be applied to the virtual machine. If such an input from the user indicates that standard users and groups should be provided access to the virtual machine, system 10 can create one or more user accounts corresponding to the one or more users which require access to the virtual machine in a directory service. System 10 can further create one or more user accounts corresponding to the one or more users which require access to the virtual machine in an identity management service. System 10 can link the corresponding user accounts between the directory service and the identity management service. System 10 can also disable, rename, or delete any user accounts that are present on the server which do not comply with security guidelines. Additionally, system 10 can add users requiring access to the server to a local administrators group, thereby granting such users enhanced access.

The user interface can request an indication as to whether the server will have SQL installed. The user interface can also request the name of the server owner. In such an example, the server owner name is linked via the identity management service.

The aforementioned features of the operating system configuration user interface are used to receive various operating system configuration parameters of the virtual machine as input by the user. It is understood that the aforementioned features are examples and that additional or alternative fields can be displayed via the user interface to collect additional or alternative operating system configuration parameters of the virtual machine.

Upon execution of operating system and application configuration module 24, system 10 can further configure the applications to be installed. In some examples, applications are installed based upon a predefined list of applications. In some examples, such applications are security applications configured to prevent unauthorized users from accessing the virtual machine.

Status verification module 26 contains instructions to verify the installation status and update status of operating system and applications within system 10. Execution of status verification module 26 via processor 12 causes system 10 to verify that the applications were installed correctly and are present on the virtual machine. Further, system 10 verifies that such applications are updated. Additionally, system 10 verifies that the operating system is up-to-date. In one embodiment, upon such verification, an electronic communication is automatically transmitted to relevant personnel. Relevant personnel can include account managers (e.g., for billing recordation), security personnel (e.g., to validate the server), and/or backup personnel (e.g., to enroll the server in backups).

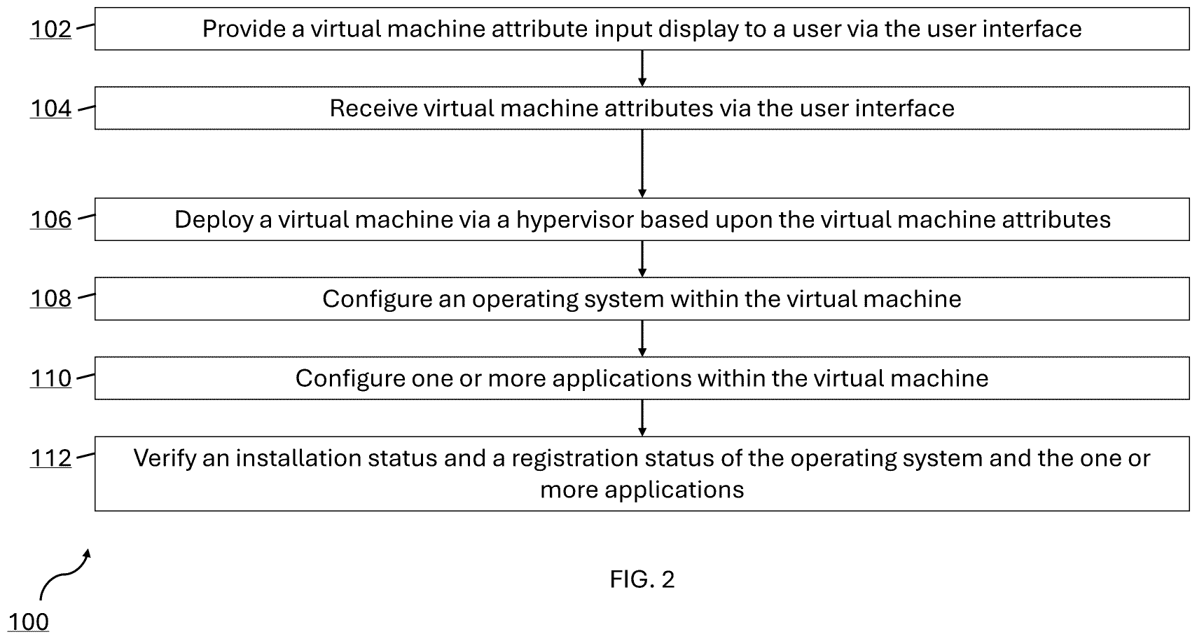

FIG. 2 depicts a flowchart describing method 100 for generating a virtual machine on a host computer. The sequence depicted is for illustrative purposes only and is not meant to limit method 100 in any way as it is understood that steps of method 100 can proceed in a different logical order, additional or intervening steps can be included, or described steps of method 100 can be divided into multiple steps, or described steps of method 100 can be omitted without detracting from the method described below.

Method 100 begins at step 102, wherein system 100 provides a virtual machine attribute input display to a user via a user interface. The user interface can be displayed on input/output device 16. At step 104, system 100 receives virtual machine attributes via the user interface based on input from the user. At step 106, system 100 deploys a virtual machine via a hypervisor based on the virtual machine attributes. At step 108, system 100 configures an operating system within the virtual machine. At step 110, system 100 configures one or more applications within the virtual machine. At step 112, system 100 verifies an installation status and a registration status of the operating system and of the one or more applications.

The techniques of this disclosure allow for automatically generating a virtual machine on a host computer. The virtual machine is configured to run a particular operating system and application software. The process by which the virtual machine is created provides the benefit of automatic creation and deployment of the virtual machine. Further, the virtual machine is customized per defined attributes. Additionally, the process ensures that the created virtual machines will be compatible with the host computer and allows for an efficient installation of necessary applications.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.
A system for generating a virtual machine on a host computer, the system 1. comprising:
a processor;
an input/output device operably connected to the processor, the input/output device configured to display a user interface; and
computer-readable memory encoded with instructions that, when executed by the processor, cause the computing device to:
   provide a virtual machine attribute input display to a user via the user interface;
   receive virtual machine attributes via the user interface;
   deploy a virtual machine via a hypervisor based upon the virtual machine attributes;
   configure an operating system within the virtual machine;
   configure one or more applications within the virtual machine; and
   verify an installation status and a registration status of the one or more applications.

2. The system of claim 1, wherein the virtual machine attributes include a hostname for the server, and wherein the computer-readable memory is further encoded with instructions that, when executed by the processor, cause the system to:
verify whether the hostname is active on a network to which the virtual machine is connected; and
verify whether Domain Name System (DNS) records exist for the hostname to determine whether the hostname is available for use.

3. The system of claim 1, wherein the virtual machine attributes include an operating system selection.

4. The system of claim 3, wherein the computer-readable memory is further encoded with instructions that, when executed by the processor, cause the system to:
display, via the user interface, one or more options for virtual machine templates available to use wherein the virtual machine templates are indicative of one or more operating systems; and
receive a selection from the user indicative of one of the one or more options for the virtual machine templates.

5. The system of claim 1, wherein the virtual machine is hosted via an external computer.

6. The system of claim 5, wherein the virtual machine attributes include a datacenter location selection indicative of a location of the external computer upon which the virtual machine is hosted.

7. The system of claim 6, wherein the computer-readable memory is further encoded with instructions that, when executed by the processor, cause the system to:
display, via the user interface, a predetermined list of one or more datacenter locations; and
receive a selection from the user indicative of one of the one or more datacenter locations.

8. The system of claim 1, wherein the virtual machine attributes include a memory quantity selection, and wherein the computer-readable memory is further encoded with instructions that, when executed by the processor, cause the system to:
display, via the user interface, a numerical input field configured to receive the memory quantity selection;
receive the memory quantity selection; and
verify an availability of the memory quantity selection.

9. The system of claim 1, wherein the virtual machine attributes include a central processing unit (CPU) quantity selection.

10. The system of claim 9, wherein the computer-readable memory is further encoded with instructions that, when executed by the processor, cause the system to:
display, via the user interface, a numerical input field configured to receive the CPU quantity selection; and
receive the CPU quantity selection; and
verify an availability of the CPU quantity selection.

11. The system of claim 10, wherein the virtual machine attributes include an indication as to whether a data disk is required, and wherein the computer-readable memory is further encoded with instructions that, when executed by the processor, cause the system to:
display, via the user interface, a Boolean input field configured to receive the indication as to whether the data disk is required;
receive the indication as to whether the data disk is required;
display a numerical field configured to receive a size of the data disk based upon the indication as to whether the data disk is required; and
receive the size of the data disk based upon the indication as to whether the data disk is required.

12. The system of claim 11, wherein the computer-readable memory is further encoded with instructions that, when executed by the processor, cause the system to:
scan the data disk to obtain a format status of the data disk; and
format the data disk in response to the format status of the data disk being unformatted.

13. The system of claim 1, wherein the computer-readable memory is further encoded with instructions that, when executed by the processor, cause the system to:
obtain an internet protocol (IP) address for the virtual machine; and
verify the IP address for the virtual machine is not in use.

14. The system of claim 1, wherein the computer-readable memory is further encoded with instructions that, when executed by the processor, cause the system to:
display a list of virtual machine attributes based a user input via the user interface;
receive a confirmation indication via the user interface indicative of whether the list of virtual machine attributes are correct.

15. The system of claim 1, wherein the computer-readable memory is further encoded with instructions that, when executed by the processor, cause the system to:
display, via the user interface, an input field configured to receive an indication of one or more users which require access to the virtual machine; and
receive the indication of the one or more users which require access to the virtual machine.

16. The system of claim 15, wherein the computer-readable memory is further encoded with instructions that, when executed by the processor, cause the system to:
create one or more user accounts corresponding to the one or more users which require access to the virtual machine in a directory service;
create one or more user accounts corresponding to the one or more users which require access to the virtual machine in an identity management service; and
link the user account within the active directory with the user accounts within the identity management service.

17. The system of claim 1, wherein the computer-readable memory is further encoded with instructions that, when executed by the processor, cause the system to:
perform an update evaluation to determine if updates are available for the operating system; and
update the operating system based upon whether updates are available for the operating system.

18. The system of claim 1, wherein the one or more applications include security software from a predefined list of security software tools.

19. The system of claim 1, wherein the computer-readable memory is further encoded with instructions that, when executed by the processor, cause the system to:
automatically send an electronic communication to security or backup system personnel with corresponding instructions for validation of the virtual machine; or
automatically send an electronic communication to an account manager with a summary of the virtual machine attributes upon the virtual machine being deployed.

20. A method for generating a virtual machine on a host computer, the method comprising:
providing a virtual machine attribute input display to a user via the user interface, the user interface displayed on an input/output device;
receiving virtual machine attributes via the user interface;
deploying a virtual machine via a hypervisor based upon the virtual machine attributes received via the user interface;
configuring an operating system within the virtual machine;
configuring one or more applications within the virtual machine; and
verifying an installation status and a registration status of the one or more applications.
